(19) United States
(12) Patent Application Publication
(10) Pub. No.: US 2009/0289075 A1
(43) Pub. Date: Nov. 26, 2009

(54) Container with closure

(76) Inventor: William Rubinstein, Brooklyn, NY (US)

Correspondence Address: Bernard Malina, Malina & Associaates, PLLC, 17th Floor, 444 Madison Avenue, New York, NY, 10022, US

(21) Appl. No.: 12/454,631

(22) Filed: May 20, 2009

Related U.S. Application Data
(60) Provisional application No. 61/055,938, filed on May 23, 2008.

(51) Int. Cl. B65D 41/16; B32B 37/00

(52) U.S. Cl. 220/780; 156/69

(57) ABSTRACT

A generally cylindrical plastic container has a metal ring-pull top cap on an upper end and a snap-fit closure on a lower end. The closure includes a tapered portion which slides into the lower end of the container and a groove portion which interlocks with a head formed on the lower end of the container.

### RELATED APPLICATIONS

The present application claims priority from my Provisional Patent Application Ser. No. 61/055,938, filed on May 23, 2008.

### FIELD OF THE INVENTION

The present invention relates generally to the field of packaging materials and more particularly, to a container with a closure which includes a transparent container.

### BACKGROUND OF THE INVENTION

The prior art related to packaging materials for retail products and includes a broad range of devices which include various types of construction, including cardboard, paperboard and plastic containers which incorporate various types of closure techniques.

Despite the broad range of prior art devices, there remains a need for a container which can display the product contained in the container and which has a closure which can be easily, quickly and securely closed and which cannot be opened easily without detection in a retail location.

A key requirement for plastic packaging devices is the prevention of unnoticed tampering at the retail site. This requirement is coupled with the requirement that the packaging device allows a consumer to open the device easily after the purchase has been made and that once opened, it is obvious that the packaging device has been opened.

### OBJECTS AND SUMMARY OF THE INVENTION

It is an object of the present invention to provide a container with a closure which includes a transparent container which can clearly display an item for purchase.

Another object of the present invention is to provide a container with a closure which can be easily snap-fit on the container.

Another object of the present invention is to provide a container with a closure which can be surreptitiously removed from the container only with relatively great difficulty.

Another object of the present invention is to provide a container with a closure which includes a ring pull top opening.

Yet another object of the present invention is to provide a container with a closure which includes a small number of component parts which can be manufactured economically in volume resulting in a relatively low unit cost.

Other objects and a more complete understanding of the invention will be made clear hereinafter.

In accordance with the present invention, there is provided a container with a closure which includes a transparent semi-rigid cylindrical container and a closure. The lower end of the container has a beaded or headed portion. The closure includes an inclined or tapered portion and a groove portion. The inclined portion is proportioned to easily enter the bottom of the container. As the closure is pressed toward the container, the headed portion slides up the inclined portion and then snaps into the groove portion. The headed end of the container and the groove portion of the closure interlock to prevent unauthorized removal of the closure from the container.

The top end of the container has a conventional metal ring-pull top similar to the metal ring-pull tops found on conventional metal beverage cans. The ring pull top makes it extremely easy for a consumer to open the container to remove the contents of the container after purchase. The ring pull-top also makes it extremely easy to notice if the container has been opened or even partially opened. The invention thus provides a structure which resists tampering and makes any tampering evident.

Additional objects and advantages of the invention will be apparent from the following detailed description when taken in conjunction with the accompanying drawings.

### BRIEF DESCRIPTION OF THE DRAWINGS

FIG. 1 is an overall perspective view of a container with closure made in accordance with the present invention;

FIG. 2 is an exploded view of the container of FIG. 1;

FIG. 3 is a fragmentary cross-sectional view taken along the line 3-3 of FIG. 2 drawn to an enlarged scale;

FIG. 4 is a fragmentary cross-sectional view taken along the line 4-4 of FIG. 1 drawn to an enlarged scale;

FIG. 5 is a top plan view of the closure taken along the line 5-5 of FIG. 2;

FIG. 6 is a bottom plan view of the closure taken along the line 6-6 of FIG. 1;

FIG. 7 is an elevation view of another alternative embodiment of the invention which incorporates a dome-like top;

FIG. 8 is a cross-sectional view of the closure similar to FIG. 4 showing an alternative embodiment of the invention which incorporates a holder for a product; and

FIG. 9 is an elevation view of another alternative embodiment of the invention which incorporates a flat top.

### DETAILED DESCRIPTION OF THE INVENTION

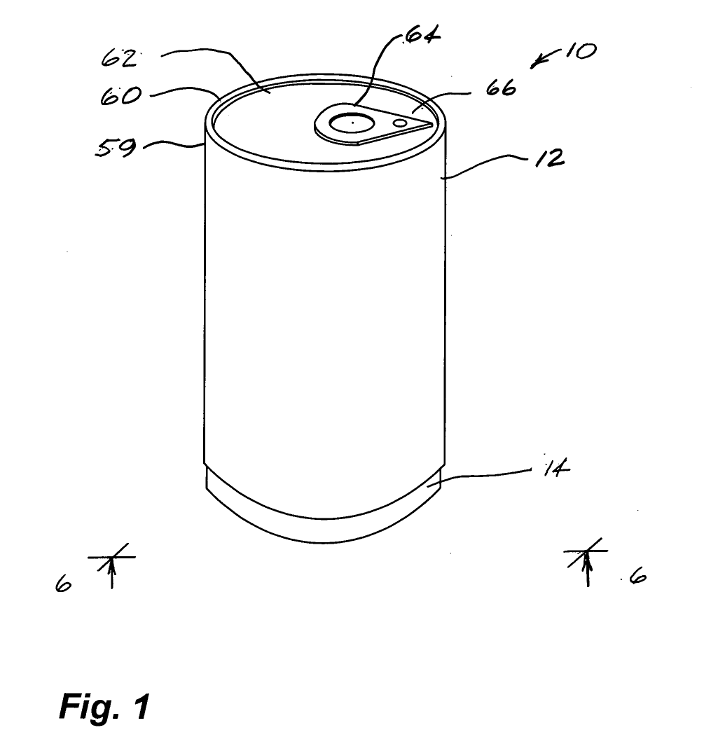

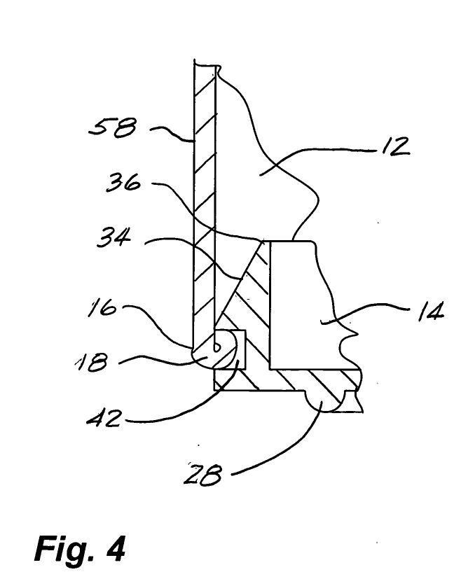

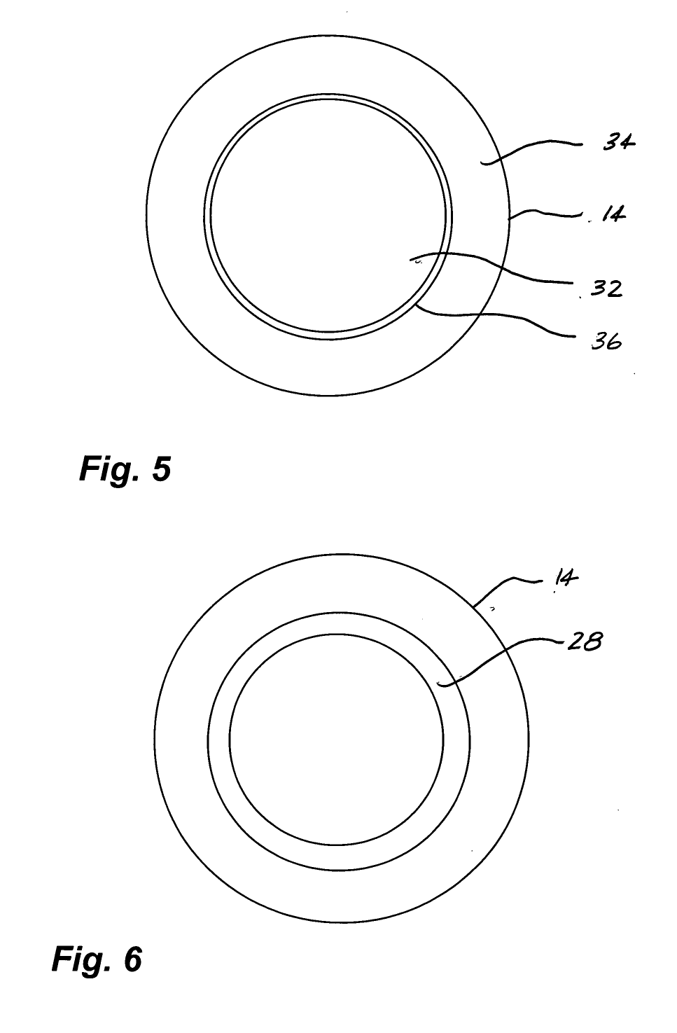

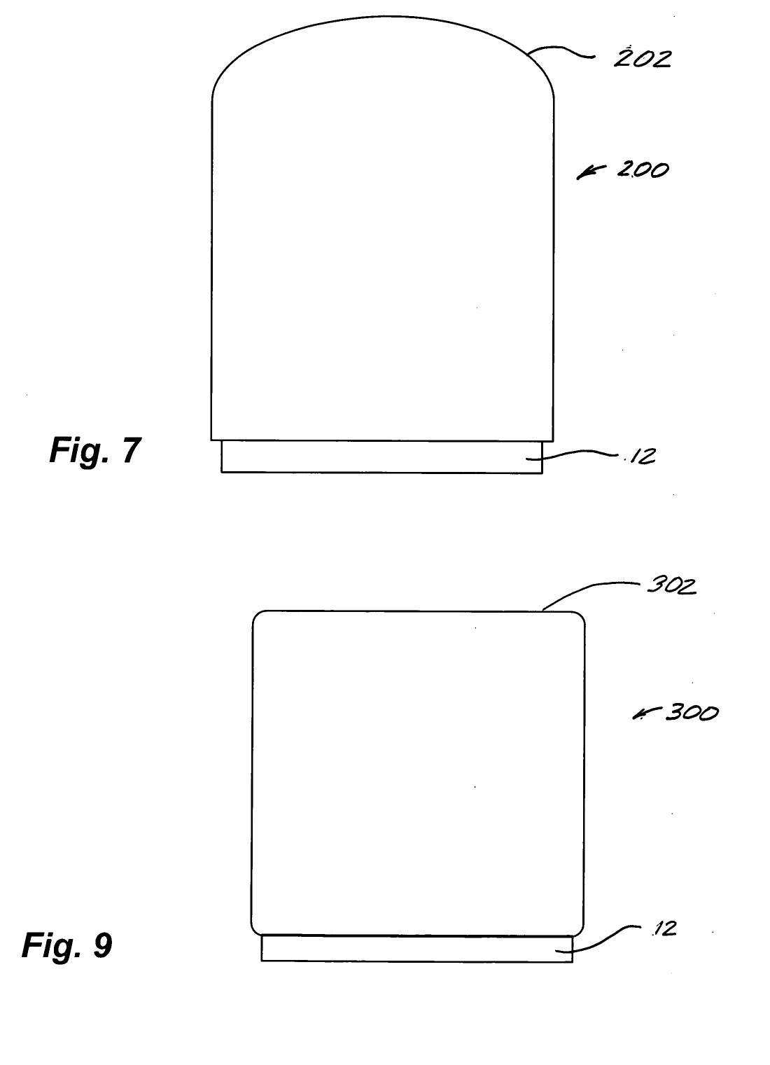

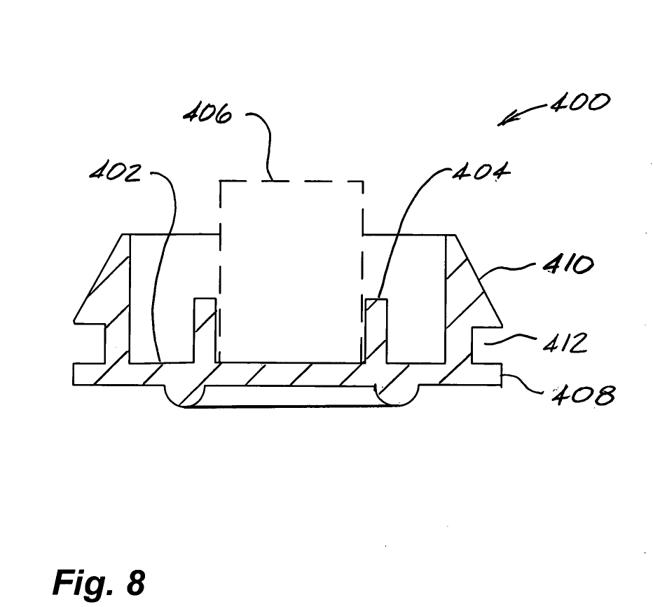

With reference to the drawings, there is shown in FIGS. 1-9 a container with a closure 10 made in accordance with the present invention which includes a generally cylindrical container 12 and snap-fit closure 14.

The container 12 is preferably made of a transparent plastic material. Preferable materials for the container 12 have been formed to be polyvinylchloride (PVC) or glycol-modified polyethyleneterephalate (PETG).

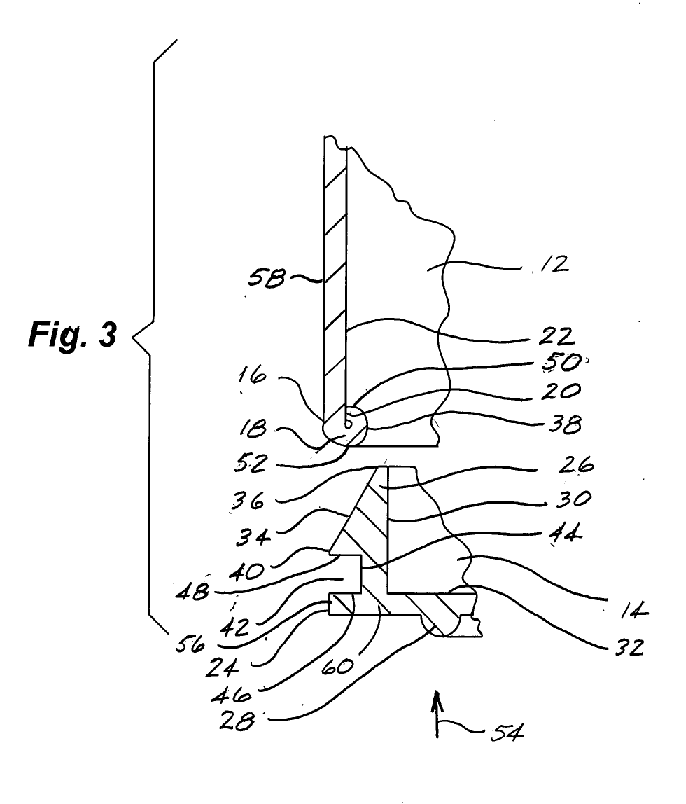

As is best shown in FIG. 3, the lower end portion 16 of the container 12 is formed as a head or bead 18 by rolling the edge 20 inward against the inner surface 22 of the container 12 during manufacture.

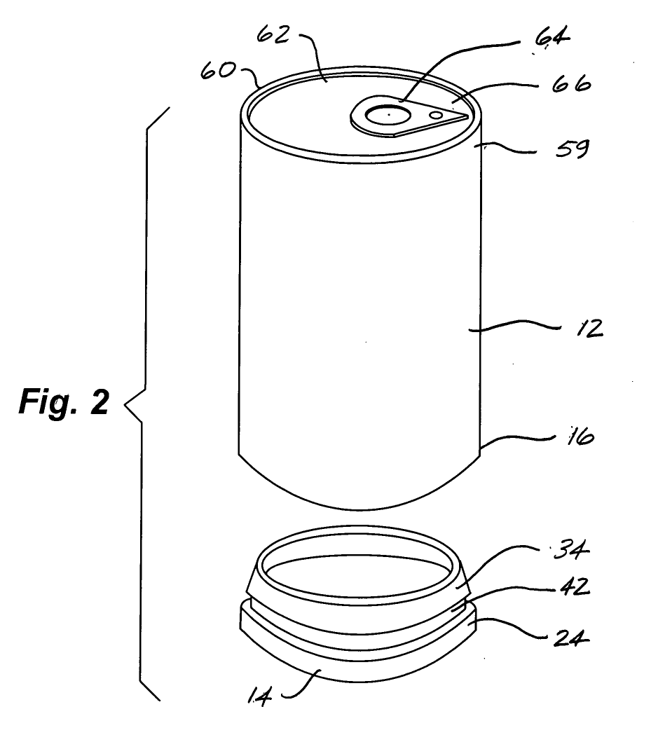

As is shown in FIGS. 2 and 3, the closure 14 is an integrally formed member which has a base portion 24, an upwardly projecting flange 26 portion and a downwardly projecting flange portion 28. The upwardly projecting flange portion 26 has an inner surface 30 which is generally perpendicular to the inner surface 32 of the base portion 24 and an outer surface 34 which is conically tapered and which forms a key feature of the present invention.

The upper end 36 of the tapered surface portion 34 has a diameter somewhat smaller than the diameter defined by the innermost portion 38, the bead portion 18 of the container 12 so that the upper end 36 of the tapered portion 34 can be easily introduced into the lower end of portion 16 of the container 12. The tapered portion 34 is tapered outwardly moving toward the base portion 24. The lower end 40 of the tapered portion 34 has a diameter greater than the diameter defined by the head portion 18 of the container 12. The tapered portion 34 is tapered outwardly moving toward the base portion 24. The lower end 40 of the tapered portion 34 has a diameter greater than the diameter defined by the head portion 18 of the container 14. The base portion 24 has a groove portion 42 adjacent to the lower end 40 of the tapered portion 34. The groove portion 42 is defined by walls 44, 46, 48. The groove wall 44 has a diameter generally equal to the diameter defined by the innermost portion 38 of the head portion 18 of the container 12. The distance between the walls 46, 48 which, in part, define the groove portion 42 is generally equal to the diameter of the head 18 as defined by the uppermost point 50 of the head 18 and the lowermost point 52 of the head 18.

During use, the closure 14 is pressed toward the container 12 in the direction shown by the arrow 54 in FIG. 3. As the closure 14 is pressed into the container 12, the head 18 and the lower portion 16 of the container flex outwardly and the head 18 slides along the tapered surface portion 34 and the head portion 18 snaps into the groove portion 42 and interlocks with the groove portion 42.

The rolled construction of the head portion 18, coupled with the semi-rigid structure of the container 12, facilitates the snap-fit and the interlocking of the closure 14 and the container 12.

The wall 56 of the base portion 24 of the closure 14 has a diameter somewhat smaller than the diameter defined by the outer surface 58 of the container 12. The downwardly projecting flange portion 28 inhibits bending of the base portion 60 and as a result, the combination of the close fitting of the groove portion 42 of the closure 14 and the container 12 and the head 18 along with the downwardly projecting flange portion 28 makes surreptitious removal of the closure 14 from the container 12 extremely difficult.

The top end 59 of the container 12 has a metal cover 60 which has a metal ring-pull top 62 which is conventional in design. The metal ring-pull top 62 is similar to tops found on beverage cans and includes a pull ring 64 which acts as a lever to open a weakened area 66 of the metal cover. The ring-pull top is conventional in nature and is, therefore, not described in detail.

Alternatively, the container 12 may be manufactured of an opaque or a translucent plastic.

In an additional alternative embodiment of the invention 200, the metal cover 60 may be replaced by a plastic dome-like cover 202.

In yet another alternative embodiment of the invention 300, the metal cover 60 may be replaced by a flat plastic cover 302.

In still another alternative embodiment of the invention 400, the upper surface 402 of the closure 408 includes a holder 404 for a product, shown schematically in broken lines 406. In the alternative embodiment of the invention 400, the container 12 is as previously described and the tapered portion 410 and the groove portion 412 are as previously described.

The present invention includes a method for forming a container with a closure 10 which includes the following steps:
forming a generally rectangular portion of a plastic material having a pair of longitudinal edges and a pair of transverse edges;
bending the rectangular portion to form a cylinder having an upper end and a lower end;
connecting the longitudinal edges using adhesive or heat sealing;
attaching a cap to the upper end;
forming a head on the lower end by bending the lower end inwardly upon itself;
forming a closure member 14 having a tapered portion and a groove portion;
inserting the tapered portion into the lower end of the cylinder to force the head and the groove to interlock, to connect the closure 14 and the cylinder or container 12.

Typically, products for retail sale may be inserted in the container 12 prior to the step of connecting the container 12 and the closure 14.

The foregoing specific embodiments of the present invention as set forth in the specification herein are for illustrative purposes only. Various deviations and modifications may be made within the spirit and scope of this invention, without departing from a main theme thereof.

What is claimed is:

1. A container with a closure comprising:
a generally cylindrical container having an upper end and a lower end, having a wall defining an interior portion with a head portion formed on said lower end;
a snap-fit closure having a closure portion disposed projecting into said interior portion and a groove portion, with said groove portion accepting and interlocking with said head portion; and
a top attached to said upper end of said container.

2. The container with a closure as claimed in claim 1 wherein said top comprises a metal ring-pull cap.

3. The container with a closure as claimed in claim 1 wherein said container is made of a plastic material.

4. The container with a closure as claimed in claim 1 wherein said container is made of a semi-rigid plastic material.

5. The container with a closure as claimed in claim 1 wherein said container is made of PVC.

6. The container with a closure as claimed in claim 1 wherein said container is made of PETG.

7. The container with a closure as claimed in claim 1 wherein said closure comprises:
a base portion having an upper surface and a lower surface;
an upwardly projecting flange portion projecting from said upper surface, with said upwardly projecting flange portion projecting into said container, with said upwardly projecting flange comprising a tapered portion.

8. The container with a closure as claimed in claim 7 wherein said closure further comprises:
a downwardly projecting flange portion projecting from said lower surface of said base.

9. The container with a closure as claimed in claim 7 wherein said downwardly projecting flange comprises:
a rounded end portion.

10. The container as claimed in claim 7 wherein said tapered portion comprises:
an upper portion of relatively smaller diameter; and
a lower portion of relatively larger diameter, with said groove portion disposed proximate to said lower portion.

11. The container with a closure as claimed in claim 7 wherein said container is transparent.

12. The container with a closure as claimed in claim 7 wherein said container is translucent.

13. The container with a closure as claimed in claim 7 wherein said container is opaque.

14. The container with a closure as claimed in claim 7 wherein said closure further comprises:
a product holder portion disposed on said upper surface of said base.

15. The container with a closure as claimed in claim 7 wherein said top comprises a plastic material.

16. A method for forming a container with a closure comprising the steps of:
forming a rectangle of a plastic material, having a pair of longitudinal edges and a pair of transverse edges;
bending said rectangle to bring longitudinal edges together to form a cylinder having an upper end and a lower end;
connecting said longitudinal edges;
attaching a cap to said upper end;
forming a head on said lower end by bending said lower end inwardly;
forming a closure having a tapered portion and a groove portion; and
inserting said tapered portion into said lower end of said cylinder to force said head and said groove portion to interlock.
